(19) United States
(12) Patent Application Publication
(10) Pub. No.: US 2007/0056199 A1
(43) Pub. Date: Mar. 15, 2007

(54) Address display

(75) Inventor: Cynthia S. Pelkowski, Alpharetta, GA (US)

Correspondence Address: PYLE & PIONTEK, 221 N. LASALLE STREET,, SUITE 2036, CHICAGO, IL, 60601, US

(73) Assignee: St. Anthony's Star LLC

(21) Appl. No.: 11/520,929

(22) Filed: Sep. 14, 2006

Related U.S. Application Data
(60) Provisional application No. 60/717,279, filed on Sep. 15, 2005.

(51) Int. Cl. G09F 7/04

(52) U.S. Cl. 40/600

(57) ABSTRACT

A magnetized display for address numbers which allows for convenient placement on surfaces such as mailboxes and steel doors is disclosed. The address display consists of a flexible vinyl material which allows decorative imprints on the outer or exterior side and magnetized vinyl on the opposite side and sheets of clear plastic with removable rectangles of the same size imprinted with sets of numbers from zero to nine thereon with adhesive backing. The desired address numbers are adhesively affixed to the guideline inscribed on the exterior side of the vinyl material. The same size number imprinted rectangles ensure equal spacing between the numbers. The display can also be used on non-magnetic materials, such as plastic or aluminum, by placing a suitable magnetic material on the opposite side to hold the magnetic display in place or introducing adhesively backed Velcro.

This is a U.S. Non-Provisional patent application which claims the benefit of and the filing date of Provisional U.S. patent application Ser. No. 60/717,279, filed Sep. 15, 2005 of the same title and relating to a means of displaying an address that is decorative and easily mounted on a mailbox, door or the like.

### BACKGROUND OF THE INVENTION

Previous means for displaying addresses are typically mounted to mailboxes or home entrances by various arrangements that puncture the mounted surface, require tools and measurement for number spacing. Others use adhesive to hold the address numbers in place. There are permanent decorative covers which encase standard mailboxes, an example is found in U.S. Pat. No. 4,712,732. There are also permanent, or removable and changeable decorative mailbox covers made of thin plastic wrapper which adhere to the mailbox by magnetic strips as described in U.S. Pat. No. 4,991,769.

### SUMMARY OF THE INVENTION

This invention is an address display, which may be in the form of an assembly or kit, comprising of a flexible, durable ultraviolet resistant vinyl material which can be imprinted with any desired design or, for example, one of several decorative designs on the exterior surface and has a magnetized thickness or under surface which is capable of solidly adhering to curved metal mailbox surfaces and/or flat metal doors and sheets of clear plastic with removable rectangles of the desired or same size imprinted with numbers that adhesively affix to the guideline inscribed on the vinyl material for the desired address. The kit includes same size rectangles to ensure desired or equal spacing of the address numbers affixed to the magnetic or vinyl material. The kit may also comprise magnetic strips with adhesive backing which can be inserted into and/or inside of and adhesively affixed to a non-magnetic mailbox to establish a field of magnetism to engage the magnetized surface of the display and hold the display to the outer surface. Alternatively, an interior magnetic piece could, preferably, be approximately the same size as the decorative background for better adherence, and used to sandwich a non-magnetic member, like a plastic or aluminum mail box. In addition, adhesively backed (hook and loop fasteners) could be applied to the mailbox/door and underside and adhesive backed mating “Velcro” applied to the magnetic background. Thus, the backgrounds could be held in place, but yet changed when desired.

### OBJECTS OF THE INVENTION

One object of this invention is to provide an address number display that is easily mounted with magnetized vinyl for mailboxes and metal doors.

Another object of this invention is to provide a simple means of affixing the desired address numbers to the display with equal spacing between the numbers.

Another object of this invention is to provide a decorative display for addresses on doors and mailboxes.

### DESCRIPTION OF DRAWINGS

FIG. 1 is an elevational view of a first vinyl magnetized address display background.

FIGS. 1A to 1E are similar to FIG. 1, but somewhat reduced in size, and show various other design backgrounds.

FIG. 2 is an elevational view of the adhesive sheet of numbers used to form the address.

FIG. 2A is a schematic that shows how the numbers may be applied.

FIG. 3 is an elevational view of the invention adhered to a steel or metal mailbox.

FIG. 4 is an elevational view of the invention adhered to a steel door.

FIG. 5 is a schematic cross-sectional view of vinyl magnetized address display adhering to a mailbox of non magnetic material with magnetic strips.

FIG. 5A is a view similar to FIG. 5, but showing the full size magnetic adhering piece inside the mailbox.

FIG. 6 shows a plastic mailbox with adhesive backed Velcro to hold the magnetic background and address number in place.

### DESCRIPTION OF THE PREFERRED EMBODIMENTS

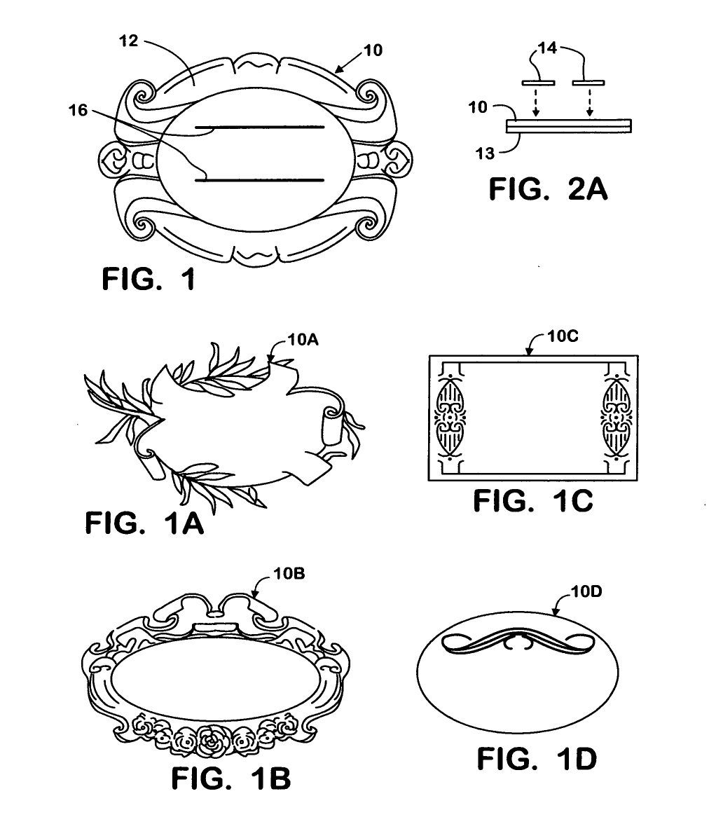

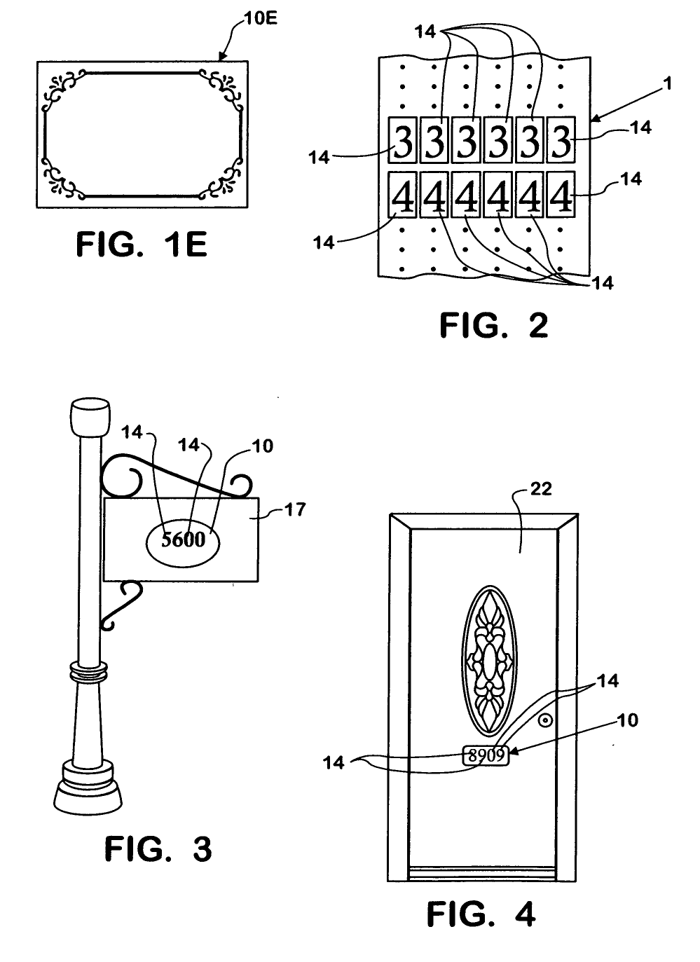

Referring to FIG. 1 there is shown a flexible, durable vinyl background material 10 that can be imprinted with various designs and decorations 12. For example, the designs (10A to 10E) can be as shown in FIGS. 1A, 1B, 1C, 1D and 1E. The body or opposite side 13 is a magnetized vinyl which, for example, solidly adheres to mailboxes 17 (FIG. 3) of iron or steel or other magnetic attractive material. This material 10 can be of the type made by Sign Mag-nificent and sold as Sign Mag-nificent. Sign Mag-nificent is owned by St. Anthony's Star, LLC, a Georgia corporation. Affixed to the vinyl material 10 are clear flexible rectangles imprinted with numbers 14 that were selected from a non-stick paper or plastic sheets 15 shown in FIG. 2 carrying several of each numbers so that addresses such as “2222” or “8888” could be formed. Such number sheet is made by Sign Mag-nificent and sold as Sign Mag-nificent It should be understood while only the numerals “3” and “4” are shown, all numbers from 0, 1, 2 . . . 8, 9 would be provided as indicated by the upper and lower continuation marks. The purchaser would then select and place the appropriate numbers for his or her address on the imprinted guide means or guidelines 16 on the vinyl material 10 for his or her address, and adhesively adhere the same. For example, the guide means could be in the form of a “T” or an inverted “T”, at the center of the number field with the adjacent numbers referenced off of this single guide mark, establishing both horizontal and vertical references.

In FIG. 2 is shown the plastic sheet 15 with removable clear plastic rectangles of the same size imprinted with numbers 14 with adhesive on the opposite side for affixing to the vinyl material 10.

In FIG. 3, the invention is shown applied to a metal mail box 17 having sufficient steel, iron or the like content to hold the magnetic sheet 10.

In FIG. 4, the invention is shown applied to a metal door 22 having sufficient steel, iron or the like content to hold the magnetic sheet 10.

Additionally, if desired, the invention could be applied to a non-magnetic door, such as made of fiberglass or wood, by installing steel or iron, such as in the form of nails or screws in the door at sufficiently close intervals to hold the magnetic sheet 10 in place.

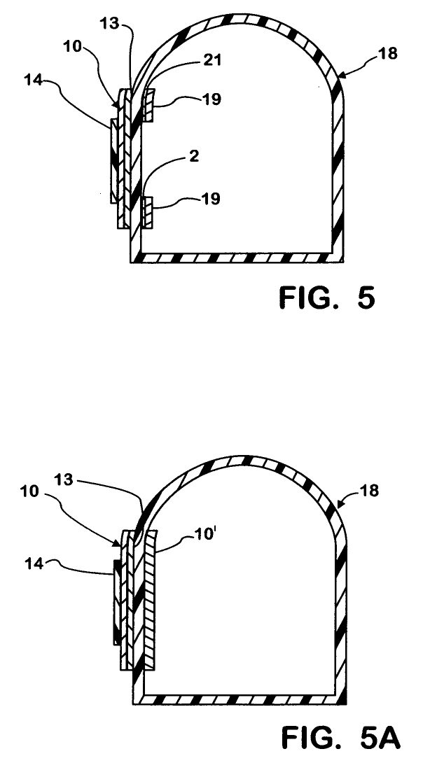

Referring to FIG. 5, the number display (FIG. 1) adheres to a non-magnetic mailbox 18, such as made of plastic or aluminum, by means of two vinyl magnetized strips 19 adhesively (adhesive 21) affixed to the interior of the non-magnetic mailbox 18. The vinyl magnetized strips establish a field of magnetism sufficient to hold the magnetized number display securely held to the mailbox. Alternatively, a similar sized magnetic inner sheet 10 could be located within the mailbox to hold the outer magnetic material 10 in place.

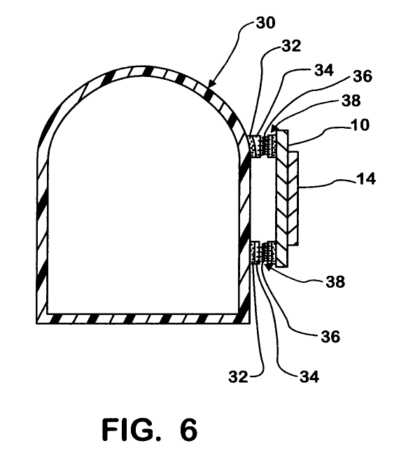

Another alternative shown in FIG. 6, is to fit the mailbox or door 30 with adhesive 32 backed Velcro 38 (hoop or loop) material 34 and providing magnetic material 10 that has similar adhesive backed associated Velcro (loop or hook) material 36. Thus, the display 10 and its desired numbers 14 is held in place but yet easily changed when desired.

While several design backgrounds have been shown, it should be understood the design could be of any form. Further, the guidelines could also be omitted. Also, means other than adhesives, such as magnetism, could be used to hold the numbers in place. While the preferred embodiments have been shown and described, it should be understood that the equivalent elements and steps could be provided and still fall within the scope of the present invention.

What is claimed is:

1. An address number display comprising a sheet having an outer surface with a decorative exterior, a magnetized under surface that allows for adherence by the force of magnetism to a magnetically attracted material, and indicia means for indicating the address on said outer surface, said indicia means being held in place on the outer surface of said sheet.

2. An address number display as in claim 1, wherein said magnetized under surface is adapted to attach to one of a mail box and door.

3. An address number display as in claim 2, wherein said one of said mail box and door is made of a magnetically attractive material.

4. An address number display as in claim 2, wherein said one of said mail box and door is made of a non-magnetically attractive material, and further comprising a magnetically attractive material attached to one of said mail box and door, said magnetically attractive material holding magnetized under surface and indicia means in place on said one of said mail box and door for indicating the address.

5. An address number display as in claim 1, wherein said magnetized under surface is adapted to attach to a mail box formed of magnetic attractive material.

6. An address number display as in claim 1, wherein said magnetized under surface is adapted to attach to a door formed of magnetic attractive material.

7. An address number display as in claim 1, wherein said indicia is held to said outer surface with a decorative exterior by fastening means.

8. An address number display as in claim 7, wherein said fastening means is magnetic attraction.

9. An address number display as in claim 7, wherein said fastening means is adhesive means.

10. An address display comprising a sheet having a decorative exterior, a magnetic means in said sheet, and indicia means for indicating an address on said sheet, said indicia means being held in place on said sheet.

11. An address display as in claim 10, comprising a set of one or more numbers and letters.

12. An address display as in claim 11, wherein said indicia includes at least four sets of numbers from 0 through 9.

13. An address display as in claim 11, wherein said indicia includes at least three sets of numbers from 0 through 9.

14. An address display as in claim 11, wherein said indicia includes alphabetic letters.

15. An address display as in claim 15, wherein said indicia includes at least one set of numerals.

16. An address display as in claim 16, wherein said indicia includes plural sets of numerals.

17. A method of forming an address on an magnetically attracted material, comprising the steps of: forming a background of imprintable material, printing a background onto the material, the material being magnetic, locating the background on the magnetically attracted material, selecting individual numbers to form the address, placing the numbers on the background to form the address, and securing the numbers to the background.

18. A method as in claim 18, comprising the further step of locating said magnetically attracted material on one of a magnetically attractive mail box and door.

19. A method as in claim 18, comprising locating a magnetically attractive material on one of a non-magnetically attractive mail box and door, placing magnetically attractive material on one of said non-magnetically attractive material mail box and door to attach said address to the same.
